(19) United States
(12) Patent Application Publication
(10) Pub. No.: US 2026/0054443 A1
(43) Pub. Date: Feb. 26, 2026

(54) Method of Manufacturing a Cartridge

(71) Applicant: Gaplast GmbH, Altenau (DE)

(72) Inventors: Stephan Kneer, Farchant (DE); Kasim Yilginc, Oberammergau (DE)

(21) Appl. No.: 19/177,185

(22) Filed: Apr. 11, 2025

(30) Foreign Application Priority Data
Aug. 20, 2024 (DE) 10 2024 123 717.1

(51) Int. Cl. B29C 49/22; B29L 31/00

(52) U.S. Cl. CPC B29C 49/22; B29C 2949/3094; B29L 2031/7174

(57) ABSTRACT

A method of manufacturing a cartridge consisting of a stiff outer container and a deformable inner bag, where an extruder coextrudes a preform, and the method includes (a) cutting away a pinch seam from the cartridge to a residual width of 0.6 to 0.15 mm, (b) laterally compressing the cartridge and at the same time, rotating the cartridge about its longitudinal axis until the pinch seam bursts open, whereby the welded base seam of the inner bag remains adhered on one side of the burst open pinch seam and the base region of the inner bag on the other side of the inner wall of the outer container is pre-delaminated, (c) producing a reduced pressure in the inner bag so that the inner bag collapses at the pre-delaminated side, and (d) subsequently completely applying the inner bag to the inner wall of the outer container by an increased pressure.

### PRIORITY CLAIM

The subject application claims convention priority to German patent application No. DE 10 2024 123 717.1, filed Aug. 20, 2024.

### BACKGROUND

The invention relates to a method of manufacturing a cartridge, which consists of a stiff outer container and a deformable inner bag. In this method, a first screw conveyor supplies a first thermoplastic plastic material for the outer container and a second screw conveyor supplies a second thermoplastic plastic material for the inner bag to an extruder, which coextrudes a preform, which is arranged between open halves of a blow mold of a blow molding installation. The two plastic materials do not form a weld connection with one another. The blow mold is closed when the preform has the length necessary for the manufacture of the cartridge, whereby a pinch seam is produced in the base region of the cartridge to be manufactured. This pinch seam consists externally of the material of the outer container, in which the welded base seam of the inner bag is clamped. The preform is thereafter inflated by a pressure medium into engagement with the wall of the blow mold, whereafter the cartridge is removed from the blow mold.

Such a method is known and is practiced in numerous variations, whereby it was previously always the practice to detach the inner bag from the wall of the outer container before filling it with the liquid or pasty filling material to be dispensed and then to apply it again to the outer container. This detaching of the inner bag adhering initially by adhesion to the inner wall of the outer container is necessary in order that the inner bag can contract when dispensing the contents of the container. In the methods of this type previously encountered, the inner bag is completely detached or delaminated from the inner wall of the outer container so that the entire contents can be discharged.

### SUMMARY

It is the object of the present invention to provide a method for the manufacture of a cartridge, which is suitable for use in an atomizer. With this usage, the cartridge contains a fluid to be atomized, which has a pharmaceutical composition and/or is a liquid medicinal preparation. When used in an atomizer, a predetermined number of spray puffs is dispensed from the cartridge, whereby the cartridge is not supposed to be completely 30 emptied, in contrast to the known possible uses.

The invention provides that, after removal of the cartridge from the blow mold and its cooling, preferably to room temperature, the pinch seam is cut away down to a remaining width of 0.6 to 0.15, preferably 0.2 mm. The pinch seam is so cut away in a cutting installation with an even and uniform cut so that preferably ca. 0.2 mm of the pinch seam 5 remain. This ensures that a sufficient pinch region of the inner bag still remains in order to ensure its liquid tightness at the base.

The cartridge is then laterally compressed and at the same time rotated about its longitudinal axis until the pinch seam opens or bursts open, whereby the welded base seam of the inner bag remains adhered on one side of the burst open pinch seam, that is to say the welded base seam of the inner bag remains bonded to one half of the pinch seam. At the same time, the base region of the inner bag at the other side of the inner wall of the outer container is slightly pre-delaminated, that is to say a little detached, whilst the inner bag on the side at which the welded base seam remains adhered in the burst open 15 pinch seam remains bonded by adhesion to the inner wall of the outer container. It is hereby ensured that, when using the cartridge, the inner bag is not folded upwardly with increasing discharge of the contents of the container since the inner bag is fixed in position on one side of the pinch seam. This detaching of the one half of the inner bag is effected in a preferred embodiment of the invention by the fact that the cartridge runs between a vertical rotating belt around a fixed belt whilst standing upright on a rotating, horizontal conveyor belt, whereby one of the two belts has a protruding contour in the lower regions of the cartridge, the spacing of which from the opposing belt is somewhat smaller than the outer diameter of the cartridge, whereby the cartridge is rotated about its vertical axis and is so compressed in the lower region that the pinch seam bursts open.

The pressure balance between the inner bag and outer container when the contents of the container are dispensed occurs through the open pinch seam.

Since the cartridge is rotated through a defined path length, preferably at least through a complete rotation, the pre-delamination does not occur abruptly, which could cause the inner bag to tear, but incrementally. Whilst rotating, the cartridge runs along a protruding contour, which is preferably formed on the fixed belt, whereby this contour can vary over the squeeze section as regards height and the protruding dimension. During the rotation of the cartridge, the inner bag becomes increasingly detached on one side of the burst open pinch seam. At the end of this process, one half of the inner bag is pre-delaminated, at least in the base region.

The cartridge is subsequently preferably transferred to a collapsing station, at which a spike pierces the cartridge and a cylinder evacuates the air trapped in the cartridge so that a reduced pressure is produced, which can be measured in the cartridge. The pre-delaminated half of the inner bag becomes completely detached from the associated inner 5 wall of the outer container from a set value of the reduced pressure.

An increased pressure is then produced in the cartridge by a switching valve so that the inner bag again fully engages the inner wall of the outer container. The cartridge is thereafter ready for use in an atomizer.

The detaching of the pre-delaminated half of the inner bag occurs with a small reduced pressure so that the welded base seam of the inner bag remains bonded in the burst open pinch seam.

When using the cartridge in an atomizer, the entire content of the cartridge is not dispensed and instead a residual volume remains in the cartridge after a predetermined number of spray puffs, which is discarded.

It is provided with great advantage in the method in accordance with the invention that the cartridge is inflated in such a shape that the base region of the cylindrical cartridge is rounded in that it extends in an arcuate shape, and symmetrically, towards the pinch seam on two opposing sides. The height of the rounded base region of the cartridge is preferably 5% to 10% of its total height.

In further detail, it is provided with advantage that the cartridge is compressed in the lower third of its height. The rotating belt should run with the same speed as the horizontal conveyor belt and it is advantageously provided that these two belts consist of textile material or rubber. The fixed vertical belt consists, on the other hand, conveniently of an aluminum alloy or of steel.

The two belts run with such a speed that the cartridge rotates at least once through 360° on the vertical belt, whereby a number of rotations through 360° can also be convenient.

As already mentioned above, the cartridge is best suited to be used in an atomizer, whereby it is preferably filled with a pharmaceutical composition and/or a liquid medicinal preparation.

### BRIEF DESCRIPTION OF THE DRAWINGS

Further details of the invention will be apparent from the following description and with reference to the drawings, in which:

FIG. 1A is a perspective view of an embodiment of the present cartridge.

FIG. 1B is a cross-sectional view of the pinch edge of the cartridge taken substantially along line 1B-1B of FIG. 1 in the direction generally indicated.

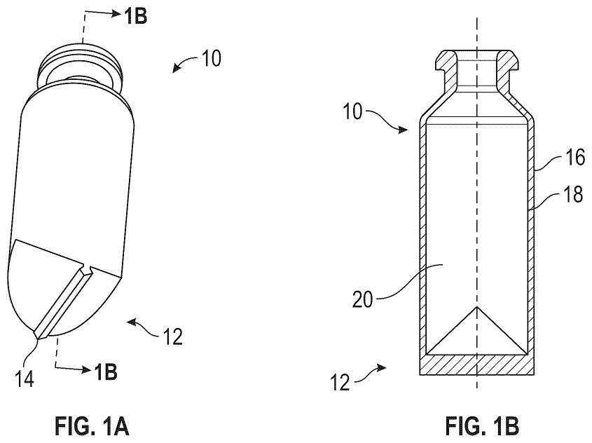

### DETAILED DESCRIPTION

The cartridge 10 has a circular cylindrical shape with a rounded base region 12, in which it extends in an arcuate shape towards the pinch seam 14 on two opposite sides. The cartridge 10 consists of a stable outer layer 16, preferably of PP, and a very adhesive, flexible inner layer 18, which preferably consists of LDPE. As a result of the rounded base region 12, the inner bag 20 may be gently detached from the outer container so that the inner bag 20 can collapse in the lower, negative millibar region, that is to say can contract without the inner bag 20 coming free from the pinch seam 14 and can bulge upwardly from below during the detaching process.

In a preferred embodiment, the cartridge 10 has the following data.
Total bottle height (including the non-severed pinch seam): 44.7+/−0.5 mm
Height of the bottle (with severed pinch seam): ca. 43.10 mm
Height of pinch seam: ca. 2 mm and after the cut ca. 0.4+/−0.2 mm
Diameter of the cartridge: 15.6+/−0.15 mm 20
Filling volume of the cartridge: 5.07+/−0.2 ml
Weight of the cartridge: 1.80+/−0.1 gr.
Material of the outer layer: PP
Layer contacting the product: LDPE
Collapsing region with filled medium: −26 mbar+/−8 mbar 25

1. A method of manufacturing a cartridge consisting of a stiff outer container and a deformable inner bag, wherein a first screw conveyor supplies a first thermoplastic plastic material for the outer container and a second screw conveyor supplies a second thermoplastic plastic material for the inner bag to an extruder, which coextrudes a preform, which is arranged between the open halves of a blow mold of a blow molding installation, wherein the blow mold is closed when the preform has the length necessary for the manufacture of the cartridge, wherein formed in the base region of the cartridge to be manufactured there is a pinch seam of material of the outer container, in which the welded base seam of the inner bag is clamped, and wherein the preform is inflated by a pressure medium into engagement with the wall of the blow mold and the cartridge is removed from the blow mold, the method the following steps:
(a) cutting away the pinch seam to a residual width of 0.6 to 0.15 mm,
(b) laterally compressing the cartridge and at the same time, rotating the cartridge about its longitudinal axis until the pinch seam bursts open, whereby the welded base seam of the inner bag remains adhered on one side of the burst open pinch seam and the base region of the inner bag on the other side of the inner wall of the outer container is pre-delaminated,
(c) producing a reduced pressure in the inner bag so that the inner bag collapses at the pre-delaminated side, and
(d) subsequently completely applying the inner bag to the inner wall of the outer container by an increased pressure.

2. The method as claimed in claim 1, wherein the cartridge is inflated in such a shape that the base region of the cylindrical cartridge is rounded in that it extends in an arcuate shape towards the pinch seam on two opposing sides.

3. The method as claimed in claim 2, wherein the height of the rounded base region of the cartridge is 5% to 10% of the total height.

4. A method as claimed in claim 1, wherein in step (b), the cartridge passes between a vertically rotating belt and a fixed belt while standing upright on a rotating horizontal conveyor belt, wherein one of the rotating belt or the fixed belt has a protruding contour in the lower region, the spacing of which from the oppositely arranged rotating belt or fixed belt is smaller than the outer diameter of the cartridge, that the cartridge rotates about its vertical axis when passing between the rotating belt and the fixed belt such that the cartridge is compressed in the lower region and causes the pinch seam to burst open.

5. The method as claimed in claim 4, wherein the fixed belt has the protruding contour.

6. The method as claimed in claim 1, wherein the cartridge is compressed in the lower third of its height.

7. The method as claimed in claim 4, wherein the rotating belt runs at the same speed as the horizontal conveyor belt.

8. The method as claimed in claim 4, wherein the vertical rotating belt and the horizontal conveyor belt consist of textile material or rubber.

9. The method as claimed in claim 4, wherein the fixed vertical belt consists of an aluminum alloy or steel.

10. The method as claimed in claim 4, wherein the rotating belt and the rotating horizontal conveyor belt run with such a speed that the cartridge rotates at least once through 360° on the vertical belt.

11. The method as claimed in claim 1, wherein the cartridge is used in an atomizer.
